(19) United States
(12) Patent Application Publication
(10) Pub. No.: US 2013/0330616 A1
(43) Pub. Date: Dec. 12, 2013

(54) Composite Particles, Methods of Making the Same, and Articles Including the Same

(71) Applicant: Leif Christensen, St. Paul, MN (US)

(72) Inventor: Leif Christensen, St. Paul, MN (US)

(73) Assignee: 3M INNOVATIVE PROPERTIES COMPANY, ST PAUL, MN (US)

(21) Appl. No.: 13/985,979

(22) PCT Filed: Feb. 3, 2012
(86) PCT No.: PCT/US12/23750

§ 371 Date: Aug. 16, 2013

Related U.S. Application Data
(60) Provisional application No. 61/444,247, filed on Feb. 18, 2011.

(51) Int. Cl. H01M 4/52

(52) U.S. Cl. CPC H01M 4/52
USPC 429/211; 427/126.3; 429/231.95; 429/223

(57) ABSTRACT

Composite particles include a core comprising a layered lithium metal oxide having an O3 crystal structure. A shell layer having an O3 crystal structure encloses the core. The shell layer includes an oxygen-loss, layered lithium metal oxide. The core comprises from 30 to 85 mole percent of the composite particles. A cathode and a lithium-ion battery including the composite particles, and methods of making the foregoing are also disclosed.

### TECHNICAL FIELD

The present disclosure broadly relates to compositions suitable for use in a cathode in a lithium-ion battery and devices including the same.

### BACKGROUND

Lithium-ion batteries can achieve the highest energy density among the known rechargeable battery systems. However, their charge-discharge cycle life, calendar life, thermal stability, and energy density still need improvement for many applications. There is constant effort to develop electrode materials, including cathode materials, with increased capacity and cycling stability. Layered mixed lithium transition metal oxides (NMC) have become popular in recent years as they provide better thermal stability than LiCoO₂ or Li(Ni_{0.8}Co_{0.15}Al_{0.05}O)₂, and they have an attractive sloping voltage profile that provides for a high average discharge voltage. NMC materials also form dense oxides that are easily coated to produce high density compressed electrodes. However, NMC materials cannot be charged above 4.4 volts (V) in a cell without causing severe fade. Thus, they do not provide a significant capacity increase.

“Excess lithium”, or, “lithium-rich” layered materials (also known in the art as “oxygen-loss” materials) (for example, see Lu et al. in Journal of The Electrochemical Society, 149 (6), A778-A791 (2002), and Arunkumar et al. in Chemistry of Materials., 19, 3067-3073 (2007)) such as Li[Li_{0.06}Mn_{0.525}Ni_{0.415}]O₂ or Li[Li_{0.2}Mn_{0.54}Ni_{0.13}Co_{0.13}]O₂ may exhibit capacities of as high as 265 mAh/g at low discharge rates (for example, see Gao et al. in Journal of Power Sources, 191, 644-647 (2009)). In lithium-excess materials, lithium, in addition to being present in a Li layer is also present in the transition metal crystal plane, sandwiched between two layers of oxygen atoms. The high capacities of these layered lithium-excess materials have been attributed to an irreversible loss of oxygen from the lattice during the first charge, and the consequent lowering of the oxidation state of the transition metal ions at the end of the first discharge, which usually manifests itself in a reduction peak below 3.5 V in the differential capacity dQ/dV.

However, such high-capacity lithium-excess layered cathode materials typically suffer from low oxide densities, low average discharge voltage, poor lithium diffusion (low rate) and large irreversible capacity (Cᵢᵣᵣ) loss in the first charge—discharge cycle. Also, they typically have an unstable crystal structure that changes with charge-discharge cycling. Therefore, despite their high capacity, the energy densities of such excess-lithium materials are not desirable, particularly at high discharge rates. Accordingly, there remains a need for cathode materials with high stability, capacity and energy.

### SUMMARY

In one aspect, the present disclosure provides composite particles, wherein each of the composite particles comprises:

a core comprising a layered lithium metal oxide having an O3 crystal structure, wherein if the layered lithium metal oxide is incorporated into a cathode of a lithium-ion cell, and the lithium-ion cell is charged to at least 4.6 volts versus Li/Li⁺ and then discharged, then the layered lithium metal oxide exhibits no dQ/dV peaks below 3.5 volts, and wherein the core comprises from 30 to 85 mole percent of the composite particle, based on the total moles of atoms of the composite particle; and

a shell layer having an O3 crystal structure enclosing the core, wherein the shell layer comprises an oxygen-loss, layered lithium metal oxide.

In another aspect, the present disclosure provides a cathode for a lithium-ion battery, the cathode comprising a current collector having a cathode composition disposed thereon, the cathode composition comprising:
composite particles according to the present disclosure;
at least one conductive diluent; and

binder.

In another aspect, the present disclosure provides a lithium-ion battery comprising an anode, a separator, an electrolyte, and a cathode according to the present disclosure.

In another aspect, the present disclosure provides a method of making composite particles, the method comprising:

forming core precursor particles comprising a first metal salt;

disposing a shell layer comprising a second metal salt on at least some of the core precursor particles to provide composite particle precursor particles, wherein the first and second metal salts are different;

drying the composite particle precursor particles to provide dried composite particle precursor particles;

combining the dried composite particle precursor particles with a lithium source material to provide a powder mixture; and

firing the powder mixture in air or oxygen to provide composite particles, wherein the composite particles each comprise:
a core comprising a layered lithium metal oxide having an O3 crystal structure, wherein if the layered lithium metal oxide is incorporated into a cathode of a lithium-ion cell, and the lithium-ion cell is charged to at least 4.6 volts versus Li/Li⁺ and then discharged, then the layered lithium metal oxide exhibits no dQ/dV peaks below 3.5 volts, and wherein the core comprises from 30 to 85 mole percent of the composite particle, based on the total moles of atoms of the composite particle; and

a shell layer enclosing the core, wherein the shell layer comprises an oxygen-loss, layered lithium metal oxide having an O3 crystal structure.

In another aspect, the present disclosure provides a method of making composite particles, the method comprising:

forming core particles comprising a layered lithium metal oxide;

disposing a shell layer comprising a metal salt on at least some of the core particles to provide composite particle precursor particles;

drying the composite particle precursor particles to provide dried composite particle precursor particles;

combining the dried composite particle precursor particles with a lithium-ion source material to provide a powder mixture; and

firing the powder mixture in air or oxygen to provide composite particles, wherein the composite particles each comprise:
a core comprising a layered lithium metal oxide having an O3 crystal structure, wherein if the layered lithium metal oxide is incorporated into a cathode of a lithium-ion cell, and the lithium-ion cell is charged to at least 4.6 volts versus Li/Li⁺ and then discharged, then the layered lithium metal oxide exhibits no dQ/dV peaks below 3.5 volts, and wherein the core comprises from 30 to 85 mole percent of the composite particle, based on the total moles of atoms of the composite particle; and
a shell layer enclosing the core, wherein the shell layer comprises an oxygen-loss, layered lithium metal oxide having an O3 crystal structure.

In another aspect, the present disclosure provides composite particles, wherein each of the composite particles comprises:

a core comprising a layered lithium metal oxide having an O3 crystal structure, wherein if both Mn and Ni are present in the core, then a molar ratio of Mn to Ni is less than or equal to one; and

a shell layer disposed on the core, wherein the shell layer comprises a oxygen-loss layered lithium metal oxide having an O3 crystal structure, wherein if both Mn and Ni are present in the shell layer, then a molar ratio of Mn to Ni is greater than one.

In another aspect, the present disclosure provides composite particles, wherein each of the composite particles comprises:

a core comprising Li[Ni_{2/3}Mn_{1/3}]O₂; and

a shell layer disposed on the core, wherein the shell layer comprises material selected from the group consisting of Li[Li_{0.2}Mn_{0.54}Ni_{0.13}Co_{0.13}]O₂ and Li[Li_{0.06}Mn_{0.525}Ni_{0.415}]O₂.

Advantageously, composite particles according to the present disclosure, and cathodes and batteries including them, are capable of high capacity per unit volume and good lithium diffusion rates, while also having good cycling stability at high charging voltages. Additionally, cathodes can be fabricated according to the present disclosure exhibiting high capacity and capable of cycling in lithium-ion cells and batteries to voltages of 4.7 volts and above, while having less than 10 percent fade per 100 full cycles if cycled at temperatures up to 50° C.

Moreover, the irreversible capacity of cathode materials according to the present disclosure can be readily adjusted by varying the core to shell ratio.

In this application:

the term “anode” refers to an electrode where electrochemical oxidation and delithiation occurs during a discharging process;

the term “capacity” refers to electrical capacity being stored or transmitted;

the phrase “layered lithium metal oxide is incorporated into a cathode of a lithium-ion cell” refers to forming a slurry of layered lithium metal oxide particles and conductive diluent particles in N-methylpyrrolidone containing dissolved polyvinylidine difluoride, coating the slurry on an aluminum current collector, removing the N-methylpyrrolidone to form a composite cathode, and then incorporating the composite cathode in a lithium-ion cell;

the term “dQ/dV” refers to the rate of change of capacity with respect to cell voltage (that is, differential capacity versus cell voltage);

the term “cathode” refers to an electrode where electrochemical reduction and lithiation occurs during a discharging process;

the terms “lithiate” and “lithiation” refer to addition of lithium to an electrode material;

the terms “delithiate” and “delithiation” refer to removal of lithium from an electrode material;

the terms “charge” and “charging” refer to a process for providing electrochemical energy to a cell;

the terms “discharge” and “discharging” refer to a process for removing electrochemical energy from a cell, for example, as when using the cell to perform desired work;

the term “layered lithium metal oxide” refers to a lithium metal oxide composition having a crystal structure with alternating layers of lithium and transition metal atoms interposed by layers of oxygen atoms, exemplified by —NaFeO₂ (R3m) (for example, this definition includes a lattice superstructure that often reduces the symmetry group to C2/m);

the phrase “O3 crystal structure” refers to a crystal structure in which oxygen planes are stacked ABCABC and lithium occupies octahedral sites;.

the term “oxygen-loss, layered lithium metal oxide” refers to layered lithium metal oxide wherein oxygen can, or has been, removed from the crystal on first charge, and is distinguished by a plateau in the voltage curve on first charge between 4.2 V and 4.8 V during which oxygen is removed from the crystal structure, and also by a dQ/dV peak below 3.5 V on discharge;

the term “excess lithium” refers to a lithium to total transition metal molar ratio that is greater than one;

the phrase “wherein if the layered lithium metal oxide is incorporated into a cathode of a lithium-ion cell, and the lithium-ion cell is charged to at least 4.6 volts versus Li/Li⁺ and then discharged, the layered lithium metal oxide exhibits no dQ/dV peaks below 3.5 volts” refers to a material wherein a plot of dQ/dV versus cell voltage, recorded to a charge voltage of at least 4.6 V and a discharge voltage recorded to 2.8 V or lower, shows no peaks below 3.5 V when the voltage curves are plotted in the dQ/dV format (that is, as dQ/dV versus cell voltage); and

The features and advantages of the present disclosure will be further understood upon consideration of the detailed description as well as the appended claims.

### BRIEF DESCRIPTION OF THE DRAWINGS

FIG. 1 is a schematic cross-sectional side view of an exemplary composite particle 100 according to the present disclosure.

FIG. 2 is a schematic cross-sectional side view of an exemplary cathode 200 according to the present disclosure.

FIG. 3 is an exploded perspective schematic view of an exemplary lithium-ion electrochemical cell 300 according to the present disclosure.

FIG. 4 is a plot of cell capacity versus charge-discharge cycle number for 2325 coin half cells containing core composition Li[Ni_{2/3}Mn_{1/3}]O₂ at ambient temperature (uncontrolled) and 50° C. cycled between 2.8 V and 4.6 V.

FIGS. 5A and 5B are plots of dQ/dV versus cell voltage of first charge and discharge for a series of Li₁₊ₓ[(Ni_{2/3}Mn_{1/3})]O_{2+x/2} core materials with excess lithium in the transition metal layer.

FIG. 6 is a plot of cell voltage versus capacity of shell composition Li[Li_{0.2}Mn_{0.54}Ni_{0.13}Co_{0.13}]O₂, cycles 1 and 2, between 2.0 V and 4.8 V.

FIG. 7 is a plot of dQ/dV versus cell voltage of first charge and discharge Li[Li_{0.2}Mn_{0.54}Ni_{0.13}Co_{0.13}]O₂, cycled between 2.8 V and 4.8 V, and constitutes an oxygen-loss material.

FIGS. 8A and 8B are SEM micrographs of metal hydroxide seed particles prepared in Example 1.

FIGS. 8C and 8D are SEM micrographs of metal hydroxide composite particles prepared in Example 1.

FIG. 9 is a plot of cell voltage versus capacity of core composition (Li[Ni_{2/3}Mn_{1/3}]O₂ (cycled between 2.0 V and 4.6 V), shell composition Li[Li_{0.2}Mn_{0.54}Ni_{0.13}Co_{0.13}]O₂, and voltage profile of the first two cycles of a cathode containing composite particles prepared in Example 1 (cycled between 2 V and 4.8V).

FIG. 10 is a plot of cell capacity versus charge-discharge cycle number for 2325 coin cells (half cells and full cells) containing the cathode prepared in Example 1 at ambient temperature (uncontrolled) and 50° C. cycled between 2 V and 4.7 V.

FIG. 11A is an SEM micrograph of metal hydroxide core seed particles prepared in Example 2.

FIG. 11B is an SEM micrograph of metal hydroxide composite particles prepared in Example 2.

FIG. 12 is a plot of cell voltage versus capacity of the first two charge-discharge cycles of a cathode containing composite particles prepared in Example 2 (cycled between 2 V and 4.8 V at 50° C.).

FIG. 13 is a plot of cell capacity versus charge-discharge cycle number for 2325 coin half cells containing the cathode prepared in Example 2 at ambient temperature (uncontrolled) and 50° C. cycled between 2 V and 4.7 V.

While the above-identified drawing figures set forth several embodiments of the present disclosure, other embodiments are also contemplated, as noted in the discussion. In all cases, this disclosure presents the disclosure by way of representation and not limitation. It should be understood that numerous other modifications and embodiments can be devised by those skilled in the art, which fall within the scope and spirit of the principles of the disclosure. The figures may not be drawn to scale. Like reference numbers may have been used throughout the figures to denote like parts.

### DETAILED DESCRIPTION

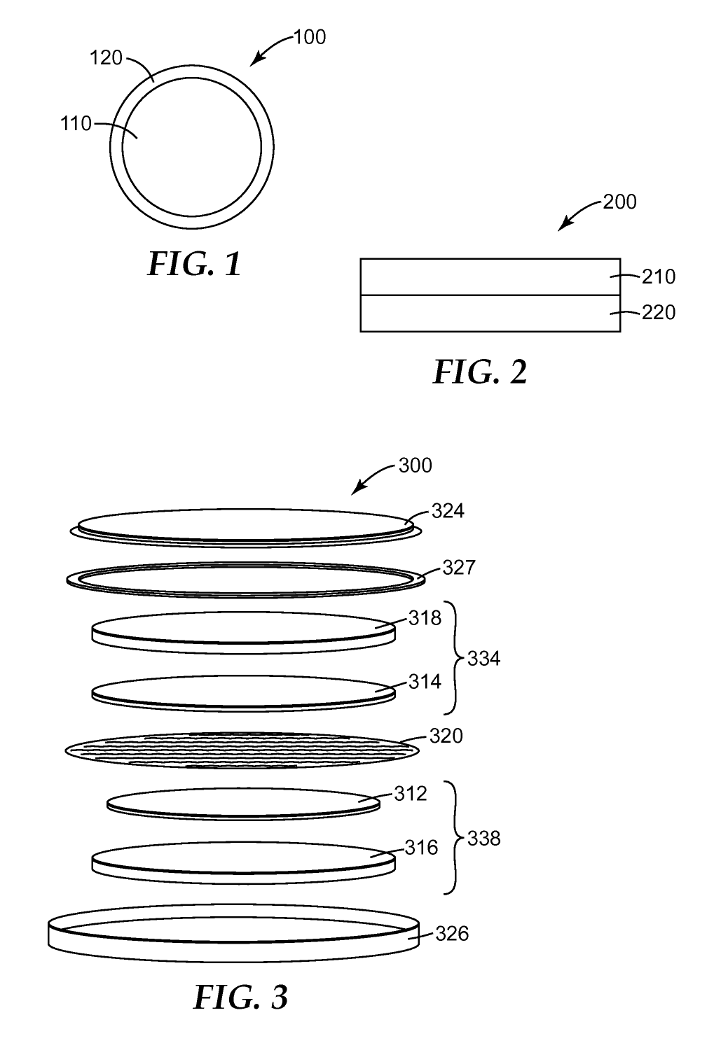

Referring now to FIG. 1, an exemplary composite particle 100 comprises core 110 and shell 120 that encloses core 110.

Core 110 comprises a layered lithium metal oxide having an O3 crystal structure. If the layered lithium metal oxide is incorporated into a cathode of a lithium-ion cell, and the lithium-ion cell is charged to at least 4.6 volts versus Li/Li⁺ and then discharged, then the layered lithium metal oxide exhibits no dQ/dV peaks below 3.5 volts. Generally, such materials have a molar ratio of Mn:Ni, if both Mn and Ni are present, that is less than or equal to one.

Examples of layered lithium metal oxides include, but are not limited to LiCoO₂, Li[Ni_{0.80}, Al_{0.05}Co_{0.15}]O₂, Li[Li_{w}NiₓMn_{y}Co_{z}Mₚ]O₂ wherein: M is a metal other than Li, Ni, Mn, or Co; 0<w,⅓; 0≦x≦1; 0≦y≦⅔; 0≦z≦1; 0<p<0.15; w+x+y+z+p=1; and the average oxidation state of the metals within the brackets is three, including Li[Ni_{0.5}Mn_{0.5}]O₂ and Li[Ni_{2/3}Mn_{1/3}]O₂. X-ray diffraction (XRD), well-known in the art, can be used to ascertain whether or not the material has a layered structure.

Certain lithium transition metal oxides do not readily accept significant additional amount of excess lithium, do not display a well-characterized oxygen-loss plateau when charged to a voltage above 4.6 V, and on discharge do not display a reduction peak below 3.5V in dQ/dV. Examples include Li[Ni_{2/3}Mn_{1/3}]O₂, Li[Ni_{0.42}Mn_{0.42}Co_{0.16} O₂, and Li[Ni_{0.5}Mn_{0.5}]O₂. Such oxides are particularly useful as core materials.

Core 110 comprises from 30 to 85 mole percent of the composite particle. In some embodiments, core 110 comprises from 50 to 85 mole percent, or from 60 to 80 or 85 mole percent, of the composite particle, based on the total moles of atoms of the composite particle.

Shell layer 120 comprises an oxygen-loss, layered lithium metal oxide having an O3 crystal structure configuration. In some embodiments, the oxygen-loss layered metal oxide comprises lithium, nickel, manganese, and cobalt in an amount allowing the total cobalt content of the composite metal oxide to be less than 20 mole percent. Examples include, but are not limited to, solid solutions of Li[Ni_{2/3}Mn_{1/3}]O₂ and Li[NiₓMn_{y}Co_{z}]O₂, wherein 0≦x≦1, 0≦y≦1, 0≦z≦0.2, and wherein x+y+z=1, and the average oxidation state of the transition metals is three, excluding the materials listed above under the core material definition that do not show particular strong oxygen loss characteristics. Particularly useful shell materials include, for example, Li[Li_{0.2}Mn_{0.54}Ni_{0.13}Co_{0.13}]O₂ and Li[Li_{0.06}Mn_{0.525}Ni_{0.415}]O₂ as well as additional materials described in Lu et al. in Journal of The Electrochemical Society, 149 (6), A778-A791 (2002), and Arunkumar et al. in Chemistry of Materials, 19, 3067-3073 (2007). Generally, such materials have a molar ratio Mn:Ni, if both present, greater than one.

Shell layer 120 comprises from 15 to 70 mole percent of the composite particle. In some embodiments, shell layer 120 comprises from 15 to 50 mole percent, or from 15 or 20 mole percent to 40 percent of the composite particle, based on the total moles of atoms of the composite particle.

The shell layer may have any thickness subject to the restrictions on composition of the composite particle described above. In some embodiments, the thickness of the shell layer is in a range of from 0.5 to 20 micrometers.

Composite particles according to the present disclosure may have any size, but desirably have an average particle diameter in a range of from 1 to 25 micrometers.

In some embodiments, the charge capacity of the composite particle is greater than the capacity of the core. This is typically desirable, but it is not a requirement.

Composite particles according to the present disclosure can be made by various methods.

In one method, core precursor particles comprising a first metal salt are formed, and used as seed particles for the shell layer, which comprises a second metal salt deposited on at least some of the core precursor particles to provide composite particle precursor particles. In this method, the first and second metal salts are different. The composite particle precursor particles are dried to provide dried composite particle precursor particles, which are combined with a lithium source material to provide a powder mixture. The powder mixture is then fired (that is, heated to a temperature sufficient to oxidize the powder in air or oxygen) to provide composite lithium metal oxide particles according to the present disclosure.

For example, a core precursor particle, and then a composite particle precursor, may be formed by stepwise (co)precipitation of one or more metal oxide precursors of a desired composition (first to form the core and then to form the shell layer) using stoichiometric amounts of water-soluble salts of the metal(s) desired in the final composition (excluding lithium and oxygen) and dissolving these salts in an aqueous solution. As examples, sulfate, nitrate, oxalate, acetate and halide salts of metals can be utilized. Exemplary sulfate salts useful as metal oxide precursors include manganese sulfate, nickel sulfate, and cobalt sulfate. The precipitation is accomplished by slowly adding the aqueous solution to a heated, stirred tank reactor under inert atmosphere, together with a solution of sodium hydroxide or sodium carbonate. The addition of the base is carefully controlled to maintain a constant pH Ammonium hydroxide additionally may be added as a chelating agent to control the morphology of the precipitated particles, as will be known by those of ordinary skill in the art. The resulting metal hydroxide or carbonate precipitate can be filtered, washed, and dried thoroughly to form a powder. To this powder can be added lithium carbonate or lithium hydroxide to form a mixture. The mixture can be sintered, for example, by heating it to a temperature of from 500° C. to 750° C. for a period of time from between one and 10 hours. The mixture can then be oxidized by firing in air or oxygen to a temperature from 700° C. to above about 1000° C. for an additional period of time until a stable composition is formed. This method is disclosed, for example, in U.S. Pat. Publ. No. 2004/0179993 (Dahn et al.), and is known to those of ordinary skill in the art.

In a second method, a shell layer comprising a metal salt is deposited on at least some of preformed core particles comprising a layered lithium metal oxide to provide composite particle precursor particles. The composite particle precursor particles are then dried to provide dried composite particle precursor particles, which are combined with a lithium-ion source material to provide a powder mixture. The powder mixture is then fired in air or oxygen to provide composite particles according to the present disclosure.

Composite particles according to the present disclosure are useful, for example, in manufacture of cathodes for lithium-ion batteries. Referring now to FIG. 2, exemplary cathode 200 comprises cathode composition 210 disposed on current collector 220.

Cathode composition 210 comprises composite particles according to the present disclosure, at least one conductive diluent, and a binder.

Examples of suitable conductive diluents include: carbon blacks such as those available as “SUPER P” and “SUPER S” from MMM Carbon, Belgium; those available as Shawinigan Black from Chevron Chemical Co., Houston, Tex.; acetylene black, furnace black, graphite, and carbon fibers. Metal particles, conductive metal nitrides, and conductive metal carbides may also be used. Combinations of two or more conductive diluents may be used.

Exemplary suitable binders include polyolefins such as those prepared from ethylene, propylene, or butylene monomers; fluorinated polyolefins such as those prepared from vinylidene fluoride monomers; perfluorinated polyolefins such as those prepared from hexafluoropropylene monomer; perfluorinated poly(alkyl vinyl ethers); perfluorinated poly(alkoxyvinyl ethers); alkali metal polyacrylates; aromatic, aliphatic, or cycloaliphatic polyimides, or combinations thereof. Specific examples of suitable binders include polymers or copolymers of vinylidene fluoride, tetrafluoroethylene, and propylene; and copolymers of vinylidene fluoride, and hexafluoropropylene.

To make a cathode, a cathode composition (for example, as discussed above) containing a binder and/or binder precursor, at least one conductive diluent, and optional components such as, for example, fillers, adhesion promoters, thickening agents for coating viscosity modification such as carboxymethylcellulose and other additives known by those skilled in the art can be mixed in a suitable coating solvent such as water or N-methylpyrrolidone (NMP) to form a coating dispersion or coating mixture. The resulting composition can be mixed thoroughly, and then applied to a current collector by any appropriate coating technique such as knife coating, notched bar coating, dip coating, spray coating, electrospray coating, or gravure coating. The current collectors can be thin foils of conductive metals such as, for example, aluminum or gold. The slurry can be coated onto the current collector, allowed to dry in air, then dried in a heated oven, typically at about 80° C. to about 300° C. for about an hour to remove all of the solvent.

Cathodes according to the present disclosure can be combined with an anode, a separator, and an electrolyte to form a lithium-ion electrochemical cell or a battery from two or more electrochemical cells.

Suitable anodes can be made, for example, from compositions that include lithium, carbonaceous materials, silicon or tin alloy compositions, lithium alloy compositions, and combinations thereof. Exemplary carbonaceous materials can include synthetic graphites such as mesocarbon microbeads (MCMB) (available from E-One Moli/Energy Canada Ltd., Vancouver, Canada), SLP30 (available from TimCal Ltd., Bodio, Switzerland), natural graphites, and hard carbons. Useful anode materials also include alloy powders or thin films. Such alloys may include electrochemically active components such as silicon, tin, aluminum, gallium, indium, lead, bismuth, and zinc and may also comprise electrochemically inactive components such as iron, cobalt, transition metal silicides and transition metal aluminides. Useful alloy anode compositions can include alloys of tin or silicon. Metal alloy compositions used to make anodes can have a nanocrystalline or amorphous microstructure. Such alloys can be made, for example, by sputtering, milling, rapid quenching or other means. Useful anode materials also include metal oxides such as Li₄Ti₅O₁₂, WO₂, SiOₓ, tin oxides, and metal sulfides such as TiS₂ and MoS₂. Other useful anode materials include tin-based amorphous anode materials such as those disclosed in U.S. Pat. Appl. Publ. No. 2005/0208378 (Mizutani et al.).

Exemplary silicon alloys that can be used to make suitable anodes include compositions that comprise from about 55 to about 85 mole percent Si, from about 5 to about 12 mole percent Fe, from about 5 to about 12 mole percent Ti, and from about 5 to about 12 mole percent C. Additional examples of useful silicon alloys include compositions that include silicon, copper, and silver or silver alloy such as those discussed in U.S. Pat. Appl. Publ. No. 2006/0046144 A1 (Obrovac et al.); multiphase, silicon-containing electrodes such as those discussed in U.S. Pat. Publ. No. 2005/0031957 (Christensen et al.); silicon alloys that contain tin, indium and a lanthanide, actinide element or yttrium such as those described in U.S. Pat. Appl. Publ. Nos. 2007/0020521, 2007/0020522, and 2007/0020528 (all to Obrovac et al.); amorphous alloys having a high silicon content such as those discussed in U.S. Pat. Appl. Publ. No. 2007/0128517 (Christensen et al.); and other powdered materials used for anodes such as those discussed in PCT Intl. Publ. No. WO 2007/044315 (Krause et al.). Anodes can also be made from lithium alloy compositions such as those of the type described in U.S. Pat. Nos. 6,203,944 and 6,436,578 (both to Turner et al.) and in U.S. Pat. No. 6,255,017 (Turner).

Suitable electrolytes can be in the form of a solid, liquid, or gel. Exemplary solid electrolytes include polymers such as polyethylene oxide, polytetrafluoroethylene, polyvinylidene difluoride, fluorine-containing copolymers, polyacrylonitrile, and combinations thereof. Examples of liquid electrolytes include ethylene carbonate, propylene carbonate, dimethyl carbonate, diethyl carbonate, ethyl-methyl carbonate, butylene carbonate, vinylene carbonate, fluoroethylene carbonate, fluoropropylene carbonate, gamma-butylrolactone, methyl difluoroacetate, ethyl difluoroacetate, dimethoxyethane, diglyme (that is, bis(2-methoxyethyl) ether), tetrahydrofuran, dioxolane, combinations thereof and other media that will be familiar to those skilled in the art. The electrolyte can be provided with a lithium electrolyte salt. Exemplary lithium salts include LiPF₆, LiBF₄, LiClO₄, lithium bis(oxalato)borate, LiN(CF₃SO₂)₂, LiN(C₂F₅SO₂)₂, LiAsF₆, LiC(CF₃SO₂)₃, and combinations thereof. Exemplary electrolyte gels include those described in U.S. Pat. No. 6,387,570 (Nakamura et al.) and U.S. Pat. No. 6,780,544 (Noh). The electrolyte can include other additives that will be familiar to those skilled in the art. For example, the electrolyte can contain a redox chemical shuttle such as those described in U.S. Pat. Nos. U.S. Pat. No. 5,709,968 (Shimizu), U.S. Pat. No. 5,763,119 (Adachi), U.S. Pat. No. 5,536,599 (Alamgir et al.), U.S. Pat. No. 5,858,573 (Abraham et al.), U.S. Pat. No. 5,882,812 (Visco et al.), U.S. Pat. No. 6,004,698 (Richardson et al.), U.S. Pat. No. 6,045,952 (Kerr et al.), and U.S. Pat. No. 6,387,571 (Lain et al.); and in U.S. Pat. Appl. Publ. Nos. 2005/0221168, 2005/0221196, 2006/0263696, and 2006/0263697 (all to Dahn et al.).

In some embodiments, lithium-ion electrochemical cells according to the present disclosure can be made by placing the anode and the cathode in the electrolyte. Typically, a microporous separator, such as CELGARD 2400 microporous material, available from Celgard LLC, Charlotte, N.C., is used to prevent the contact of the negative electrode directly with the positive electrode. This can be especially important in coin cells such as, for example, 2325 coin cells as known in the art.

Referring now to FIG. 3, a 2325 coin-type electrochemical cell 300 includes stainless steel cap 324 and oxidation resistant case 326 enclosing the cell and serving as negative and positive terminals, respectively. Anode 334 is formed from anode composition 314 disposed on current collector 318. Cathode 338 includes cathode composition 312 disposed on current collector 316. Separator 320, which separates the anode and cathode is wetted with electrolyte (not shown).

Lithium-ion batteries according to the present disclosure are useful, for example, in a variety of devices, including portable computers, tablet displays, personal digital assistants, mobile telephones, motorized devices (for example, personal or household appliances and vehicles), instruments, illumination devices (for example, flashlights) and heating devices. One or more electrochemical cells of this invention can be combined to provide a battery pack. Further details as to the construction and use of lithium-ion cells and battery packs will be familiar to those skilled in the art.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

### Preparation of Layered Lithium Metal Oxide Core Materials A1-A6

A 10-liter closed stirred tank reactor was equipped with 3 inlet ports, a gas outlet port, a heating mantle, and a pH probe. To the tank was added 4 liters of 1M deaerated ammonium hydroxide solution. Stirring was commenced and the temperature was maintained at 60° C. The tank was kept inerted with an argon flow. Through one inlet port was pumped a 2M solution of NiSO₄.6H₂O and MnSO₄.H₂O (Ni/Mn molar ratio of 2:1) at a rate of 4 ml/min. Through a second inlet port was added a 50 percent aqueous solution of NaOH at a rate to maintain a constant pH of 10.0 in the tank. Through the third inlet port was added concentrated aqueous ammonium hydroxide at a rate adjusted to maintain a 1M NH₄OH concentration in the reactor. Stirring at 1000 rpm was maintained. After 10 hrs, the sulfate and ammonium hydroxide flow was stopped, and the reaction was maintained for 12 hrs at 60° C. and 1000 rpm with the pH controlled at 10.0. The resulting precipitate was filtered, washed carefully several times, and dried at 110° C. for 10 hrs to provide a dry metal hydroxide in the form of spherical particles.

Aliquots (10 g) of this metal hydroxide were rigorously mixed in a mortar with an appropriate amount of LiOH.H₂O to form Li₁₊ₓ[(Ni_{2/3}Mn_{1/3})]O_{2+x/2} wherein x=0, 0.02, 004, 0.08, 0.15, and 0.5. The mixed powders were fired in air at 500° C. for 4 hrs then at 900° C. for 16 hrs to form respective layered lithium metal oxide core materials A1-A6 having O3 crystal structure. X-ray analysis of samples A1-A6 showed that for x=0.15, and x=0.5, not all Li was incorporated into the O3 structure, as some Li₂O peaks appeared.

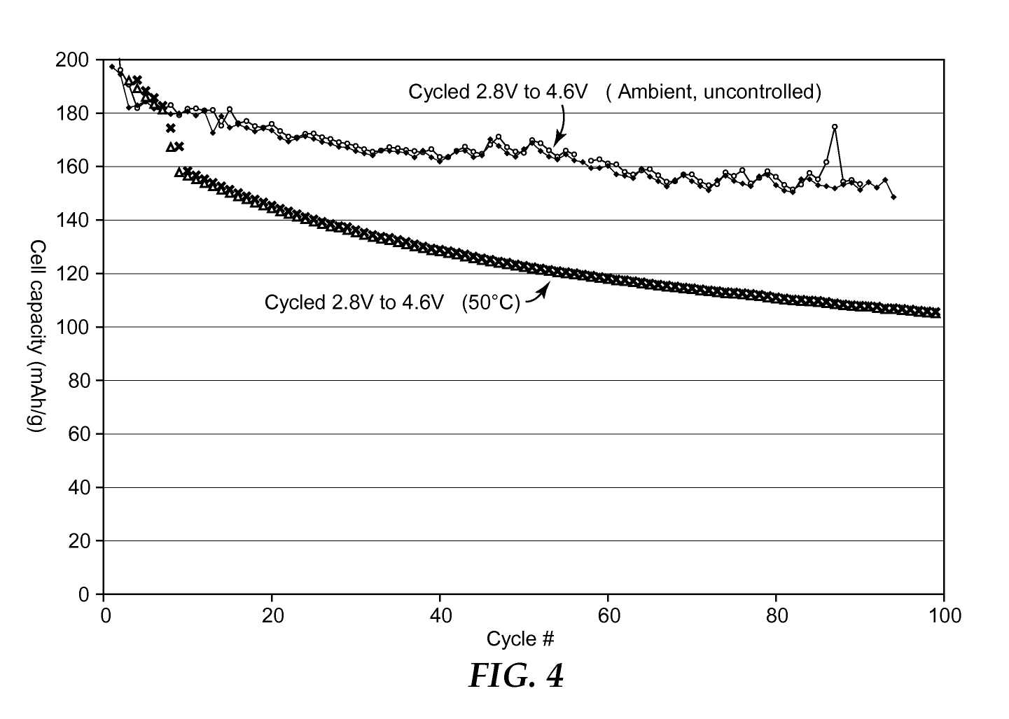

Li[Ni_{2/3}Mn_{1/3}]O₂ (lithium metal oxide core material A1) was dispersed in N-methylpyrrolidone (NMP) solvent together with Super P conductive carbon black (from MMM Carbon, Belgium) and polyvinylidine difluoride (PVDF) (from Aldrich Chemical Co.) to form a cathode dispersion composed of 90 weight percent oxide, 5 weight percent Super P and 5 weight percent of PVDF. The dispersion was coated on aluminum foil using a stainless steel coating bar, and dried at 110° C. for 4 hrs to form a composite cathode coating. Compressing the cathode coating using a calender nip demonstrated that the composite cathode could be densified to 3.5 g/cm³. The cathode thus formed from core material A1 was incorporated into 2325 coin cell half cells as known to one skilled in the art with metallic lithium foil as the counter electrode. Two layers of separators were used, one was CELGARD 2400 microporous membrane (PP) (25 micron thickness, from Celgard, Charlotte, N.C.), the other was a blown polyethylene microfiber web, (basis weight=40 g/m², 10 mils thickness). Lithium hexafluorophosphate (LiPF₆), 1M in ethylene carbonate/diethyl carbonate (1:2), was used as the electrolyte. The coin cells were cycled using a Maccor series 2000 Cell cycler (available from Maccor Inc. Tulsa, Okla., USA) at ambient temperature (uncontrolled) and at 50° C. (controlled) between 2 V and 4.6 V as reported in FIG. 4. Significant fading was observed during cycling of the coin cell.

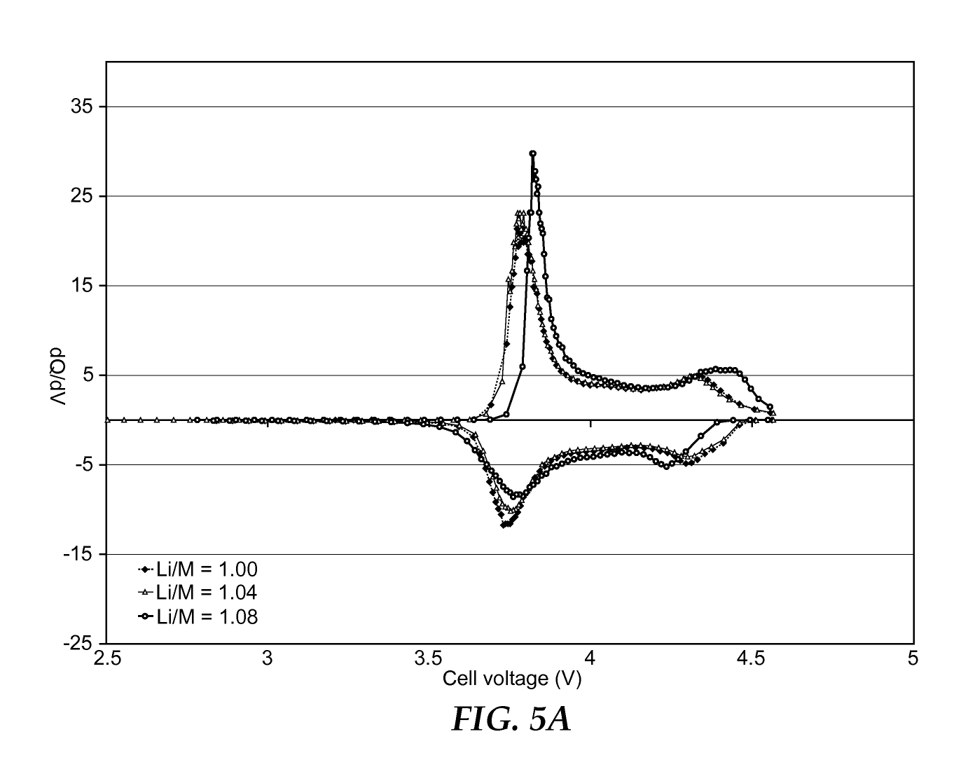

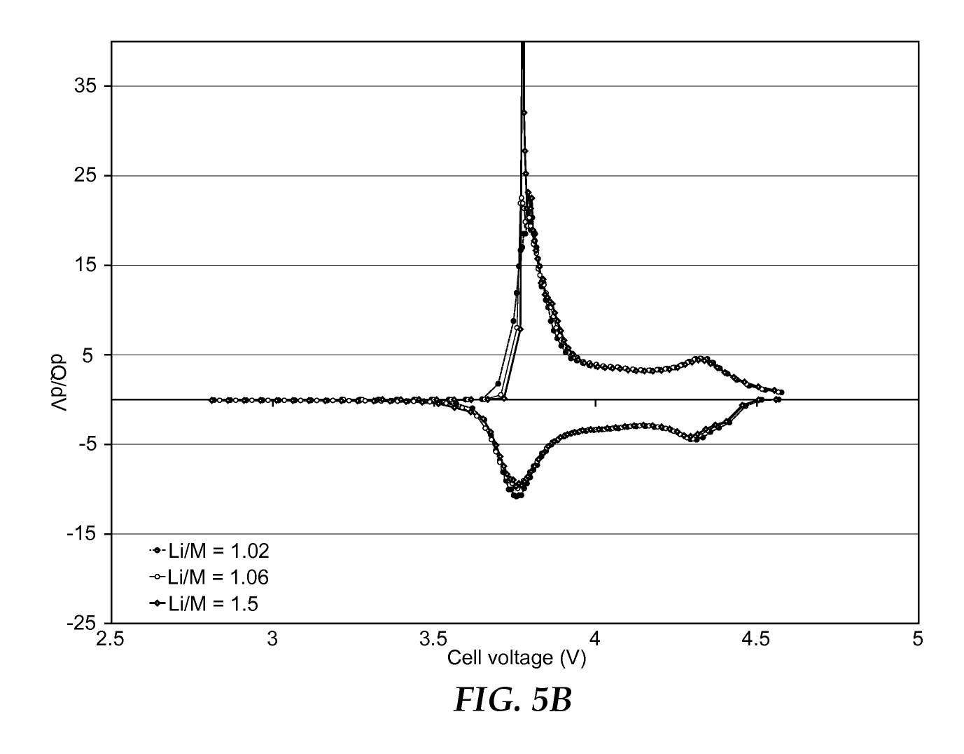

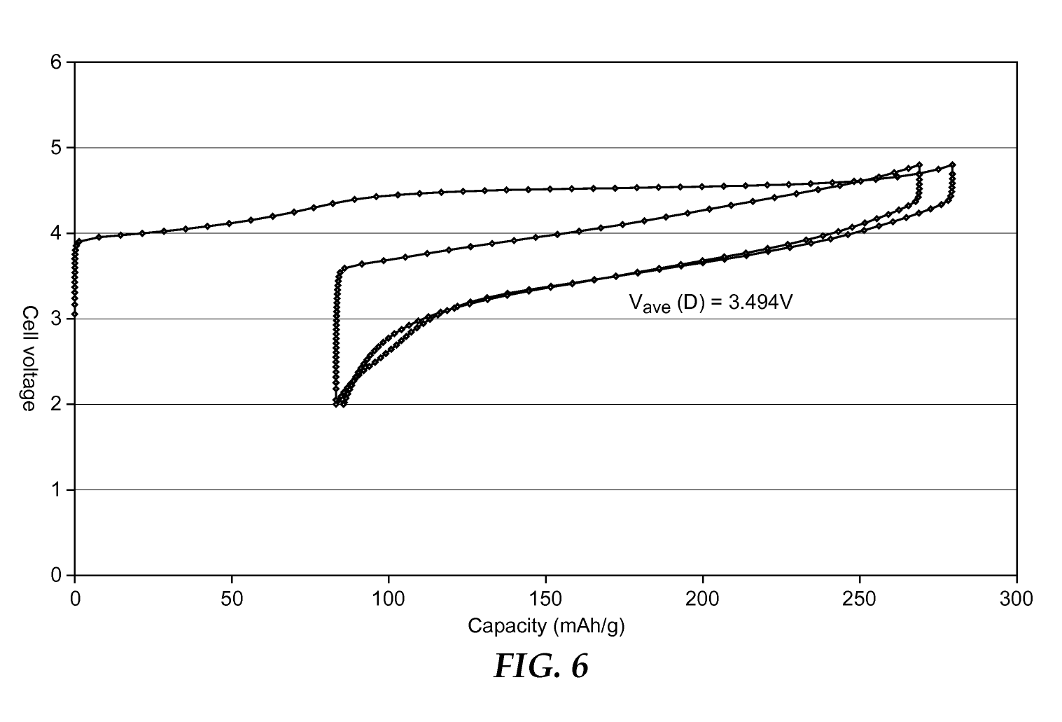

The Li₁₊ₓ[(Ni_{2/3}Mn_{1/3})]O_{2+x/2}, x>1 oxide powders were similarly converted into composite electrode coatings and 2325 coin cell half cells. The cells were cycled through one charge cycle to 4.6 V and one discharge cycle to 2.8 V. The differential capacity curves dQ/dV are reported in FIG. 5. None of the lithium rich oxides of this transition metal composition displayed any significant oxidation peak around 4.6V versus Li/Li⁺, and had no reduction peak below 3.5 V versus Li/Li⁺ in the differential capacity curves dQ/dV.

### Preparation of Shell Material B1

A stirred tank reactor was set up as above, except that the ammonia feed was kept closed, and 4 liters of deaerated 0.2M ammonium hydroxide was added. Stirring was kept at 1000 rpm, and the temperature was maintained at 60° C. The tank was kept inerted with an argon flow. Through one inlet port was pumped a 2M solution of NiSO₄.6H₂O, MnSO₄.H₂O, and CoSO₄.7H₂O (metal atomic ratio Mn/Ni/Co=67.5/17.25/17.25) at a flow rate of 4 ml/min. Through a second inlet port was added a 50 percent aqueous solution of NaOH at a rate to maintain constant pH at 10.0 in the reactor. After 10 hrs the sulfate flow was stopped, and the reaction maintained for 12 hrs at 60° C. and 1000 rpm with the pH controlled at 10.0. The resulting precipitate was filtered, washed carefully several times, and dried at 110° C. for 10 hrs to provide a dry metal hydroxide as spherical particles.

A 10 g aliquot of the dry metal hydroxide was rigorously mixed in a mortar with an appropriate amount of LiOH.H₂O to form Li[Li_{0.2}Mn_{0.54}Ni_{0.13}Co_{0.13}]O₂ after firing. The mixed powder was fired in air at 500° C. for 4 hrs then at 900° C. for 16 hrs to form a single phase layered lithium metal oxide having 03 crystal structure.

The Li[Li_{0.2}Mn_{0.54}Ni_{0.13}Co_{0.13}]O₂ was converted as in the Preparation of Layered Lithium Metal Oxide Core Material A1 (above) into a composite cathode slurry of composition 90 weight percent layered lithium metal oxide, 5 weight percent Super P conductive carbon black (from MMM Carbon), and 5 weight percent polyvinylidine difluoride (PVDF) (from Aldrich Chemical Co.) in NMP. The slurry was coated on aluminum foil and dried to provide a composite cathode. Compressing the cathode composition using a calender nip demonstrated that the cathode composition could be densified to 2 g/cm³.

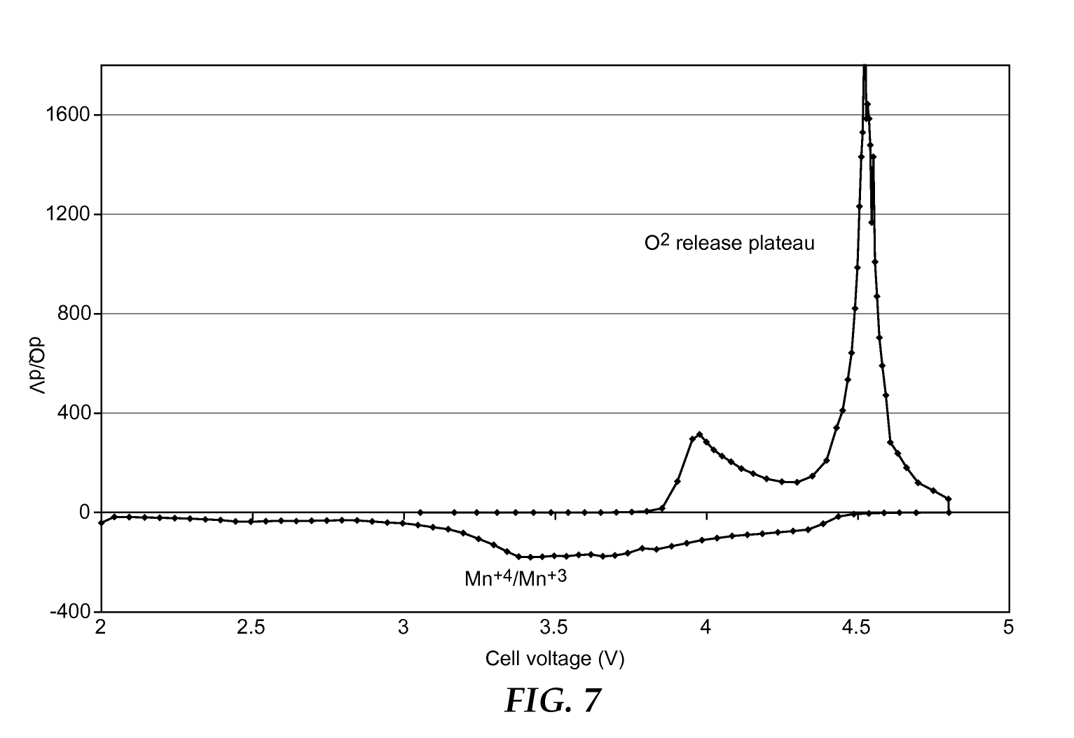

The cathode was cycled in 2325 coin cells between 4.8 V and 2.0 V. The voltage curve is reported in FIG. 5, and the dQ/dV curve is reported in FIG. 7. In FIG. 7 the very strong oxidation peak resulting from the oxygen release plateau as well as the reduction peak at ˜3.2V normally associated with the Mn⁴⁺/Mn³⁺ couple is apparent, in contrast to that of the Li₁₊ₓ[(Ni_{2/3}Mn_{1/3})]O_{2+x/2} core material reported in FIGS. 5A, 5B.

### EXAMPLE 1

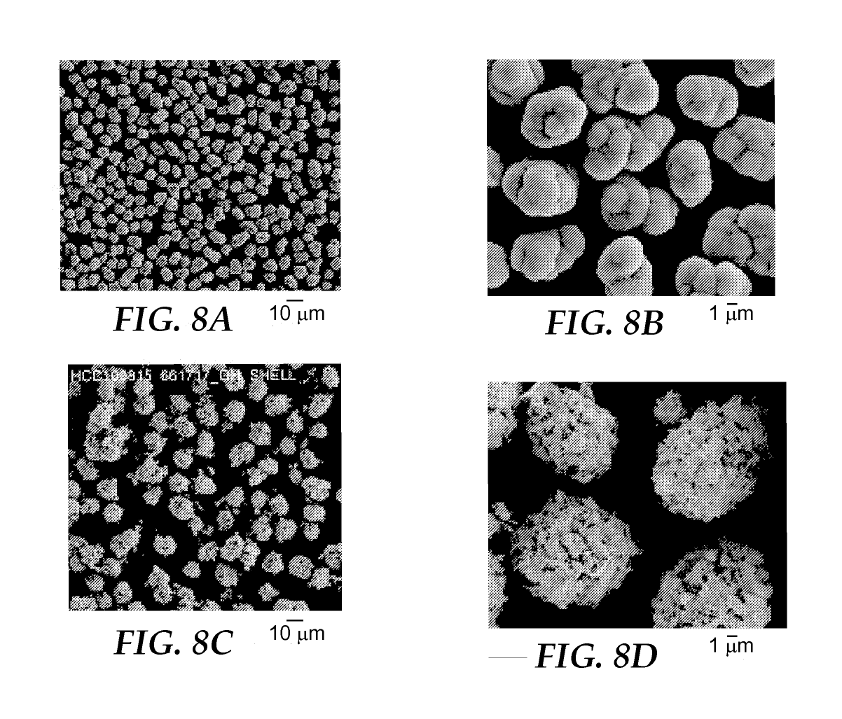

A stirred tank reactor was set up as above, except that the ammonia feed was kept closed. Deaerated ammonium hydroxide (4 liters, 0.2M) was added. Stirring was kept at 1000 rpm, and the temperature was maintained at 60° C. The tank was kept inerted with an argon flow. Metal hydroxide material from the Preparation of Layered Lithium Metal Oxide Core Material A1 (200 g) was added as seed particles. Through one inlet port was pumped a 2M solution of NiSO₄.6H₂O, MnSO₄.H₂O, and CoSO₄.7H₂O (metal atomic ratio Mn/Ni/Co=67.5/17.25/17.25) at a flow rate of 2 ml/min. Through a second inlet port was added a 50 percent aqueous solution of NaOH at a rate to maintain constant pH at 10.0 in the reactor. After 6 hrs, the sulfate flow was stopped, and the reaction maintained for 12 hrs at 60° C. and 1000 rpm, with the pH kept at 10.0. During this process, a shell coating was formed around the seed particles. The resulting precipitate was filtered, washed carefully several times, and dried at 110° C. for 10 hrs to provide a dry metal hydroxide as spherical composite particles (shown in FIGS. 8A, 8B (seed particles) and FIGS. 8C, 8D (composite particles)). Based on energy dispersive X-ray spectroscopy (EDX) analysis, the core/shell mole ratio was estimated as 30/70.

A portion of the composite particles (10 g) was rigorously mixed in a mortar with the appropriate amount of LiOH.H₂O to form Li[Ni_{2/3}Mn_{1/3}]O₂ (30 mole percent core) with Li[Li_{0.2}Mn_{0.54}Ni_{0.13}Co_{0.13}]O₂. (70 mole percent shell) after firing. The mixed powder was fired in air at 500° C. for 4 hrs then at 900° C. for 12 hrs to form composite particles with each of the core and shell having a layered lithium metal oxide having O3 crystal structure. Based on inductively coupled plasma (ICP) analysis the core/shell mole ratio was 39/61.

Following the procedure from above the composite particles was incorporated into a composite electrode composed of 90 weight percent layered lithium metal oxide, 5 weight percent Super P, and 5 weight percent polyvinylidine difluoride (PVDF) coated on aluminum foil. The composite cathode could be densified to 2.8 g/cm³ using a calender nip.

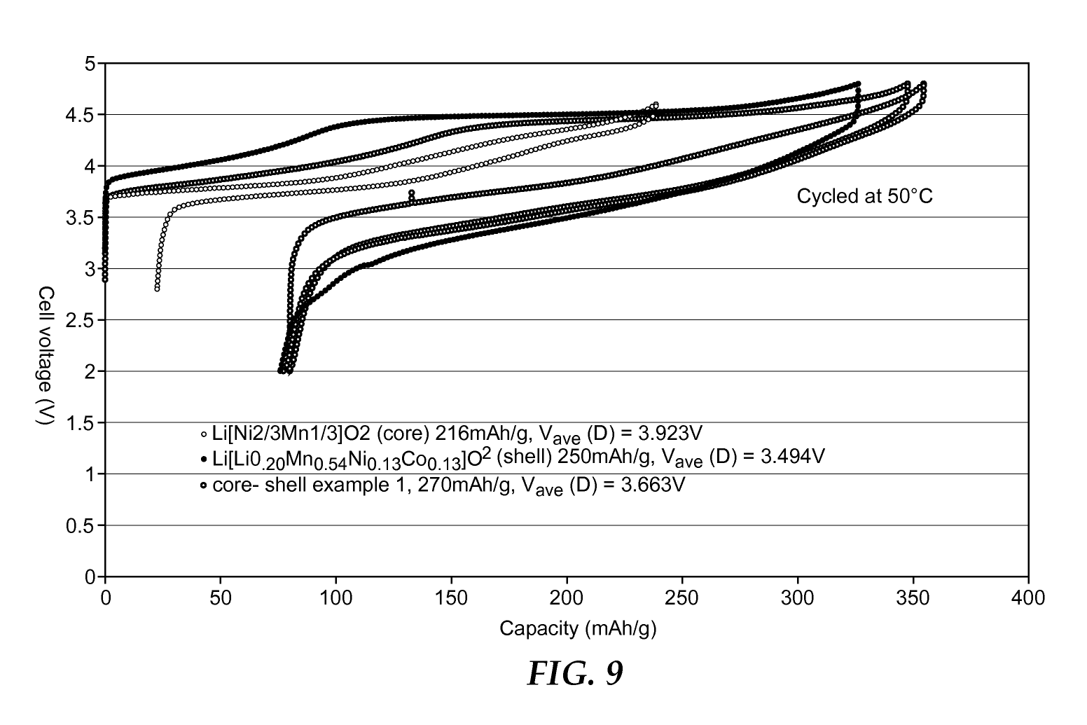

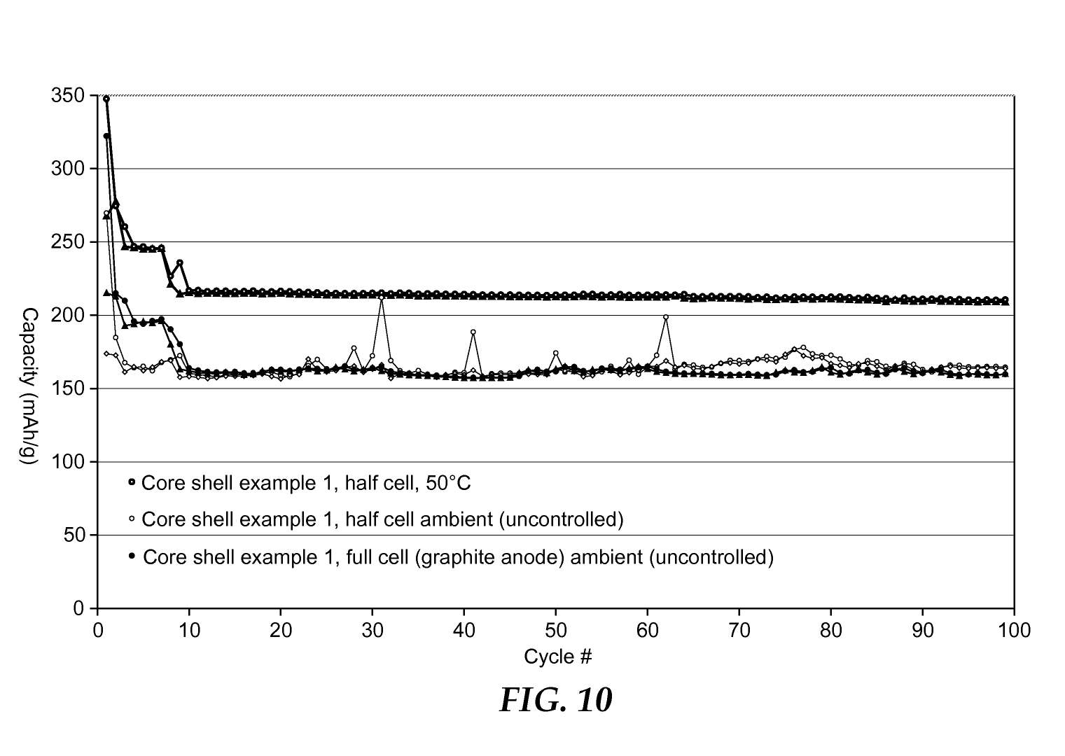

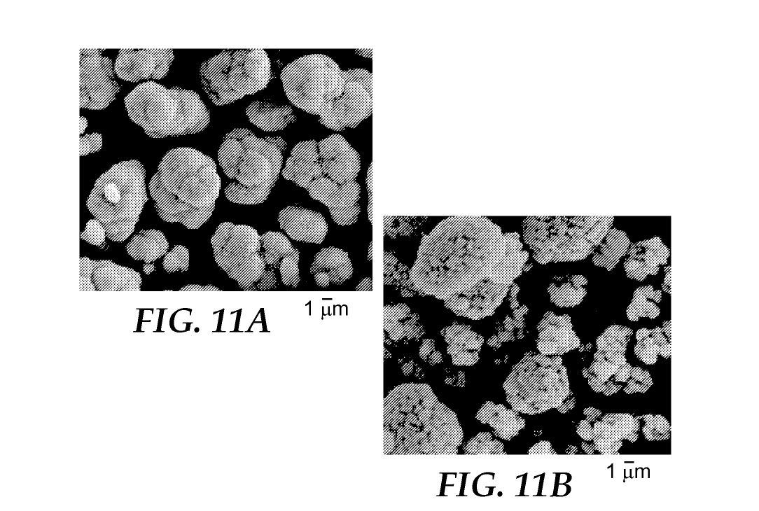

The cathode was tested in coin cell half cells assembled as described above. Additionally, full cell 2325 coin cells were assembled using an anode coating of MAG-E graphite from Hitachi Lt. (Tokyo, Japan). The cells were cycled between 2.0 V and 4.8 V for the first two cycles then between 2.0 V and 4.7 V for the following cycles at both ambient temperature (uncontrolled) as well as at 50° C. (controlled). The individual voltage curves for the core material, the shell material, and the composite composition are reported in FIG. 9, and the charge-discharge cycle life is reported in FIG. 10. The coin cells containing composite particles cycled more than 100 charge-discharge cycles at 50° C. with substantially no capacity fade, significantly better than coin cells with the core material itself.

### EXAMPLE 2

A stirred tank reactor was set up as above, except the ammonia feed was kept closed. Deaerated ammonium hydroxide (4 liters, 0.2 M) was added. Stirring was kept at 1000 rpm, and the temperature was maintained at 60° C. The tank was kept inerted with an argon flow. Metal hydroxide material from the Preparation of Layered Lithium Metal Oxide Core Material A1 (200 g) was added as seed particles. Through one inlet port was pumped a 2M solution of NiSO₄.6H₂O and MnSO₄.H₂O (metal atomic ratio Mn/Ni=55.9/44.1) at a flow rate of 2 ml/min. Through a second inlet port was added a 50 percent aqueous solution of NaOH at a rate to maintain constant pH at 10.0 in the reactor. After 4 hrs the sulfate flow was stopped, and the reaction maintained for 12 hrs at 60° C. and 1000 rpm with the pH kept at 10.0. During this process a shell coating was formed around the seed particles. The resulting precipitate was filtered, washed carefully several times, and dried at 110° C. for 10 hrs to provide a dry metal hydroxide as spherical composite particles (shown in FIG. 11A (seed particles) and FIG. 11B (composite particles)).

A portion (10 g) of the composite metal hydroxide particles was rigorously mixed in a mortar with the appropriate amount of LiOH.H₂O to form Li[Ni_{2/3}Mn_{1/3}]O₂ (80 mole percent core) with Li[Li_{0.06}Mn_{0.525 Ni}_{0.415}]O₂. (20 mole percent shell) after firing. The mixed powder was fired in air at 500° C. for 4 hrs then 900° C. for 12 hrs to form composite particles with each of the core and shell having a layered lithium metal oxide having O3 crystal structure.

Following the procedure from above the composite particles were incorporated into a composite electrode composed of 90 weight percent layered lithium metal oxide, 5 weight percent Super P, and 5 weight percent polyvinylidine difluoride (PVDF) coated on aluminum foil. The composite cathode was densified to 3.1 g/cm³ using a calender nip.

The cathode was tested in coin cell half cells assembled as described above.

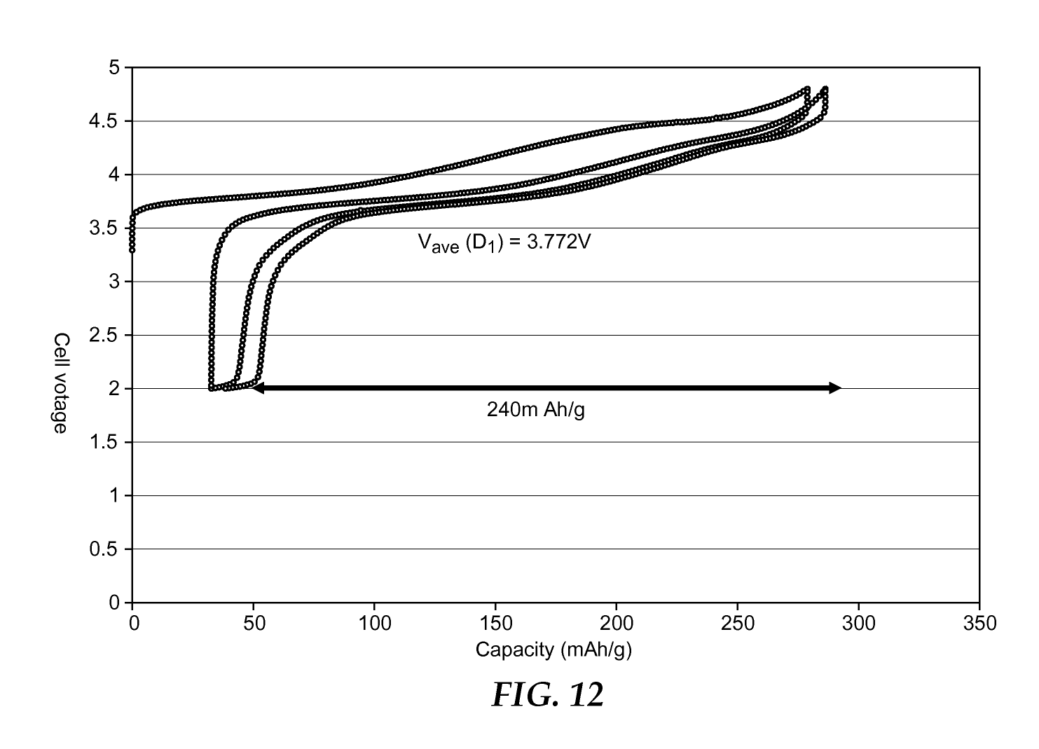

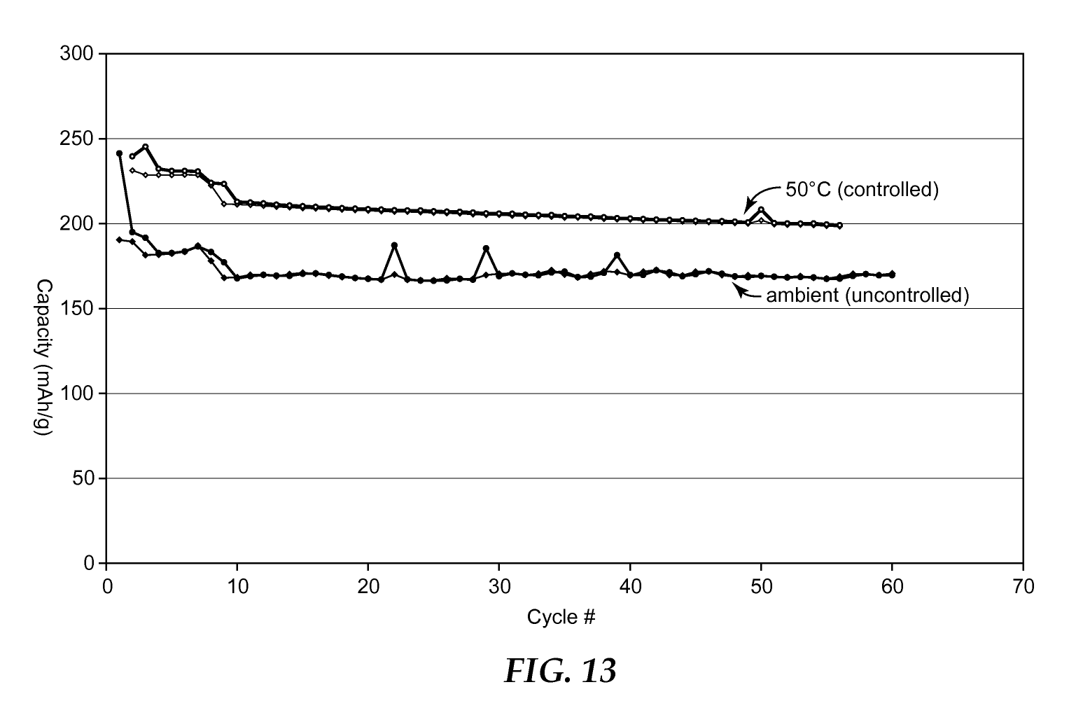

The cells were cycled between 2.0 V and 4.8 V for the first two cycles, then between 2.0 V and 4.7 V for the following cycles at both ambient temperature (uncontrolled) as well as 50° C. (controlled). The voltage curves for the cells are reported in FIG. 12, and the charge-discharge cycle life in FIG. 13. The composite particles were much improved relative to the core material itself, and that the capacity of the core-shell material is higher.

### SELECT EMBODIMENTS OF THE PRESENT DISCLOSURE

In a first embodiment, the present disclosure provides composite particles, wherein each of the composite particles comprises:

a core comprising a layered lithium metal oxide having an O3 crystal structure, wherein if the layered lithium metal oxide is incorporated into a cathode of a lithium-ion cell, and the lithium-ion cell is charged to at least 4.6 volts versus Li/Li⁺ and then discharged, then the layered lithium metal oxide exhibits no dQ/dV peaks below 3.5 volts, and wherein the core comprises from 30 to 85 mole percent of the composite particle, based on the total moles of atoms of the composite particle; and

a shell layer having an O3 crystal structure enclosing the core, wherein the shell layer comprises an oxygen-loss, layered lithium metal oxide.

In a second embodiment, the present disclosure provides composite particles according to the first embodiment, wherein the capacity of the composite particle is greater than the capacity of the core.

In a third embodiment, the present disclosure provides composite particles according to the first or second embodiments, wherein the layered lithium metal oxide comprises nickel, manganese, and cobalt, and wherein the total cobalt content in the composite particle is less than 20 mole percent.

In a fourth embodiment, the present disclosure provides composite particles according to any one of the first to third embodiments, wherein the shell layer is selected from the group consisting of Li[Li_{0.2}Mn_{0.54}Ni_{0.13}Co_{0.13}]O₂ and Li[Li_{0.06}Mn_{0.525}Ni_{0.415}]O₂.

In a fifth embodiment, the present disclosure provides composite particles according to any one of the first to fourth embodiments, wherein the core comprises Li[Ni_{2/3}Mn_{1/3}]O₂.

In a sixth embodiment, the present disclosure provides composite particles according to any one of the first to fifth embodiments, wherein Mn and Ni are present in the shell layer in a first molar ratio of Mn to Ni that is greater than one.

In a seventh embodiment, the present disclosure provides composite particles according to the sixth embodiment, wherein Mn and Ni are present in the core in a second molar ratio of Mn to Ni, less than or equal to one.

In an eighth embodiment, the present disclosure provides a cathode for a lithium-ion battery, the cathode comprising a current collector having a cathode composition disposed thereon, the cathode composition comprising:
composite particles according to any one of the first to seventh embodiments;
at least one conductive diluent; and
a binder.

In a ninth embodiment, the present disclosure provides a cathode for a lithium-ion battery according to the eighth embodiment, wherein the cathode has a density of greater than or equal to 2.8 grams per cubic centimeter.

In a tenth embodiment, the present disclosure provides a lithium-ion battery comprising an anode, a separator, an electrolyte, and a cathode according to the eighth or ninth embodiment.

In an eleventh embodiment, the present disclosure provides a lithium-ion battery according to the tenth embodiment, wherein the lithium-ion battery is capable of being cycled with charging to 4.6 V versus Li/Li⁺ with a capacity fade of less than 10 percent after 100 charge-discharge cycles.

In a twelfth embodiment, the present disclosure provides a method of making composite particles, the method comprising:

forming core precursor particles comprising a first metal salt;

disposing a shell layer comprising a second metal salt on at least some of the core precursor particles to provide composite particle precursor particles, wherein the first and second metal salts are different;

drying the composite particle precursor particles to provide dried composite particle precursor particles;

combining the dried composite particle precursor particles with a lithium source material to provide a powder mixture; and

firing the powder mixture in air or oxygen to provide composite particles, wherein the composite particles each comprise:
a core comprising a layered lithium metal oxide having an O3 crystal structure, wherein if the layered lithium metal oxide is incorporated into a cathode of a lithium-ion cell, and the lithium-ion cell is charged to at least 4.6 volts versus Li/Li⁺ and then discharged, then the layered lithium metal oxide exhibits no dQ/dV peaks below 3.5 volts, and wherein the core comprises from 30 to 85 mole percent of the composite particle, based on the total moles of atoms of the composite particle; and

a shell layer enclosing the core, wherein the shell layer comprises an oxygen-loss, layered lithium metal oxide having an O3 crystal structure.

In a thirteenth embodiment, the present disclosure provides a method according to the twelfth embodiment, wherein the capacity of the composite particle is greater than the capacity of the core.

In a fourteenth embodiment, the present disclosure provides a method according to the twelfth or thirteenth embodiment, wherein the layered lithium metal oxide comprises nickel, manganese, and cobalt, and wherein the total cobalt content in the composite particle is less than 20 mole percent.

In a fifteenth embodiment, the present disclosure provides a method according to any one of the twelfth to fourteenth embodiments, wherein the shell layer is selected from the group consisting of Li[Li_{0.2}Mn_{0.54}Ni_{0.13}Co_{0.13}]O₂ and Li[Li_{0.06}Mn_{0.525}Ni_{0.415}]O₂.

In a sixteenth embodiment, the present disclosure provides a method according to any one of the twelfth to fifteenth embodiments, wherein the core comprises Li[Ni_{2/3}Mn_{1/3}]O₂.

In a seventeenth embodiment, the present disclosure provides a method of making composite particles, the method comprising:

forming core particles comprising a layered lithium metal oxide;

disposing a shell layer comprising a metal salt on at least some of the core particles to provide composite particle precursor particles;

drying the composite particle precursor particles to provide dried composite particle precursor particles;

combining the dried composite particle precursor particles with a lithium-ion source material to provide a powder mixture; and

firing the powder mixture in air or oxygen to provide composite particles, wherein the composite particles each comprise:
a core comprising a layered lithium metal oxide having an O3 crystal structure, wherein if the layered lithium metal oxide is incorporated into a cathode of a lithium-ion cell, and the lithium-ion cell is charged to at least 4.6 volts versus Li/Li⁺ and then discharged, then the layered lithium metal oxide exhibits no dQ/dV peaks below 3.5 volts, and wherein the core comprises from 30 to 85 mole percent of the composite particle, based on the total moles of atoms of the composite particle; and
a shell layer enclosing the core, wherein the shell layer comprises an oxygen-loss, layered lithium metal oxide having an O3 crystal structure.

In an eighteenth embodiment, the present disclosure provides a method according to the seventeenth embodiment, wherein the capacity of the composite particle is greater than the capacity of the core.

In a nineteenth embodiment, the present disclosure provides a method according to the seventeenth or eighteenth embodiment, wherein the layered lithium metal oxide comprises nickel, manganese, and cobalt, and wherein the total cobalt content in the composite particle is less than 20 mole percent.

In a twentieth embodiment, the present disclosure provides a method according to to any one of the seventeenth to nineteenth embodiments, wherein the shell layer is selected from the group consisting of Li[Li_{0.2}Mn_{0.54}Ni_{0.13}Co_{0.13}]O₂ and Li[Li_{0.06}Mn_{0.525}Ni_{0.415}]O₂.

In a twenty-first embodiment, the present disclosure provides a method according to any one of the seventeenth to twentieth embodiments, wherein the core comprises Li[Ni_{2/3}Mn_{1/3}]O₂.

In a twenty-second embodiment, the present disclosure provides composite particles, wherein each of the composite particles comprises:

a core comprising a layered lithium metal oxide having an O3 crystal structure, wherein if both Mn and Ni are present in the core, then a molar ratio of Mn to Ni is less than or equal to one; and

a shell layer disposed on the core, wherein the shell layer comprises a oxygen-loss layered lithium metal oxide having an O3 crystal structure, wherein if both Mn and Ni are present in the shell layer, then a molar ratio of Mn to Ni is greater than one.

In a twenty-third embodiment, the present disclosure provides composite particles according to the twenty-second embodiment, wherein the capacity of the composite particle is greater than the capacity of the core.

In a twenty-fourth embodiment, the present disclosure provides composite particles according to the twenty-second or twenty-third embodiment, wherein the layered lithium metal oxide comprises nickel, manganese, and cobalt, and wherein the total cobalt content in the composite particle is less than 20 mole percent.

In a twenty-fifth embodiment, the present disclosure provides composite particles according to any one of the twenty-second to twenty-fourth embodiments, wherein the shell layer is selected from the group consisting of Li[Li_{0.2}Mn_{0.54}Ni_{0.13}Co_{0.13}]O₂ and Li[Li_{0.06}Mn_{0.525}Ni_{0.415}]O₂.

In a twenty-sixth embodiment, the present disclosure provides composite particles according to any one of the twenty-second to twenty-fifth embodiments, wherein the core comprises Li[Ni_{2/3}Mn_{1/3}]O₂.

In a twenty-seventh embodiment, the present disclosure provides composite particles according to any one of the twenty-second to twenty-sixth embodiments, wherein Mn and Ni are present in the shell layer in a first molar ratio of Mn to Ni that is greater than one.

In a twenty-eighth embodiment, the present disclosure provides composite particles according to any one of the twenty-second to twenty-seventh embodiments, wherein Mn and Ni are present in the core in a second molar ratio of Mn to Ni, less than or equal to one.

In a twenty-ninth embodiment, the present disclosure provides a cathode for a lithium-ion battery, the cathode comprising a current collector having a cathode composition disposed thereon, the cathode composition comprising:
composite particles according to any one of the twenty-second to twenty-eighth embodiments;
at least one conductive diluent; and
a binder.

In a thirtieth embodiment, the present disclosure provides am cathode according to the twenty-ninth embodiment, wherein the cathode has a density of greater than or equal to 2.8 grams per cubic centimeter.

In a thirty-first embodiment, the present disclosure provides a lithium-ion battery comprising an anode, a separator, an electrolyte, and a cathode according to the twenty-ninth or thirtieth embodiment.

In a thirty-second embodiment, the present disclosure provides a lithium-ion battery according to the thirty-first embodiment, wherein the lithium-ion battery is capable of being cycled with charging to at least 4.6 V versus Li/Li+ with a capacity fade of less than 10 percent after 100 charge-discharge cycles.

In a thirty-third embodiment, the present disclosure provides a method of making composite particles, the method comprising:

forming core precursor particles comprising a first metal salt;

disposing a shell layer comprising a second metal salt on at least some of the core precursor particles to provide composite particle precursor particles, wherein the first and second metal salts are different;

drying the composite particle precursor particles to provide dried composite particle precursor particles;

combining the dried composite particle precursor particles with a lithium source material to provide a powder mixture; and

firing the powder mixture in air or oxygen to provide composite particles, wherein the composite particles each comprise:
a core comprising a layered lithium metal oxide having an O3 crystal structure, wherein if both Mn and Ni are present in the core, then a molar ratio of Mn to Ni is less than or equal to one; and
a shell layer disposed on the core, wherein the shell layer comprises a oxygen-loss layered lithium metal oxide having an O3 crystal structure, wherein if both Mn and Ni are present in the shell layer, then a molar ratio of Mn to Ni is greater than one.

In a thirty-fourth embodiment, the present disclosure provides a method according to the thirty-third embodiment, wherein the capacity of the composite particle is greater than the capacity of the core.

In a thirty-fifth embodiment, the present disclosure provides a method according to the thirty-third or thirty-fourth embodiment, wherein the layered lithium metal oxide comprises nickel, manganese, and cobalt, and wherein the total cobalt content in the composite particle is less than 20 mole percent.

In a thirty-sixth embodiment, the present disclosure provides a method according to any one of the thirty-third to thirty-fifth embodiments, wherein the shell layer is selected from the group consisting of Li[Li_{0.2}Mn_{0.54}Ni_{0.13}Co_{0.13}]O₂ and Li[Li_{0.06}Mn_{0.525}Ni_{0.415}]O₂.

In a thirty-seventh embodiment, the present disclosure provides a method according to any one of the thirty-third to thirty-sixth embodiments, wherein the core comprises Li[Ni_{2/3}Mn_{1/3}]O₂.

In a thirty-eighth embodiment, the present disclosure provides a method of making composite particles, the method comprising:

forming core particles comprising a layered lithium metal oxide;

disposing a shell layer comprising a metal salt on at least some of the core particles to provide composite particle precursor particles;

drying the composite particle precursor particles to provide dried composite particle precursor particles;

combining the dried composite particle precursor particles with a lithium-ion source material to provide a powder mixture; and

firing the powder mixture in air or oxygen to provide composite particles, wherein the composite particles each comprise:
a core comprising a layered lithium metal oxide having an O3 crystal structure, wherein if the layered lithium metal oxide is incorporated into a cathode of a lithium-ion cell, and the lithium-ion cell is charged to at least 4.6 volts versus Li/Li+ and then discharged, then the layered lithium metal oxide exhibits no dQ/dV peaks below 3.5 volts, and wherein the core comprises from 30 to 85 mole percent of the composite particle, based on the total moles of atoms of the composite particle; and
a shell layer enclosing the core, wherein the shell layer comprises an oxygen-loss, layered lithium metal oxide having an O3 crystal structure.

In a thirty-ninth embodiment, the present disclosure provides a method according to the thirty-eighth embodiment, wherein the capacity of the composite particle is greater than the capacity of the core.

In a fortieth embodiment, the present disclosure provides a method according to the thirty-eighth or thirty-ninth embodiment, wherein the layered lithium metal oxide comprises nickel, manganese, and cobalt, and wherein the total cobalt content in the composite particle is less than 20 mole percent.

In a forty-first embodiment, the present disclosure provides a method according to any one of the thirty-eighth to fortieth embodiments, wherein the shell layer is selected from the group consisting of Li[Li_{0.2}Mn_{0.54}Ni_{0.13}Co_{0.13}]O₂ and Li[Li_{0.06}Mn_{0.525}Ni_{0.415}]O₂.

In a forty-second embodiment, the present disclosure provides a method according to any one of the thirty-eighth to forty-first embodiments, wherein the core comprises Li[Ni_{2/3}Mn_{1/3}]O₂.

In a forty-third embodiment, the present disclosure provides composite particles, wherein each of the composite particles comprises:
a core comprising Li[Ni_{2/3}Mn_{1/3}]O₂; and
a shell layer disposed on the core, wherein the shell layer comprises material selected from the group consisting of Li[Li_{0.2}Mn_{0.54}Ni_{0.13}Co_{0.13}]O₂ and Li[Li_{0.06}Mn_{0.525}Ni_{0.415}]O₂.

Various modifications and alterations of this disclosure may be made by those skilled in the art without departing from the scope and spirit of this disclosure, and it should be understood that this disclosure is not to be unduly limited to the illustrative embodiments set forth herein.

1-43. (canceled)

44. Composite particles, wherein each of the composite particles comprises:
a core comprising a layered lithium metal oxide having an O3 crystal structure, wherein if the layered lithium metal oxide is incorporated into a cathode of a lithium-ion cell, and the lithium-ion cell is charged to at least 4.6 volts versus Li/Li+ and then discharged, then the layered lithium metal oxide exhibits no dQ/dV peaks below 3.5 volts, and wherein the core comprises from 30 to 85 mole percent of the composite particle, based on the total moles of atoms of the composite particle; and
a shell layer having an O3 crystal structure enclosing the core, wherein the shell layer comprises an oxygen-loss, layered lithium metal oxide.

45. The composite particles of claim 44, wherein the capacity of the composite particle is greater than the capacity of the core.

46. The composite particles of claim 44, wherein the layered lithium metal oxide comprises nickel, manganese, and cobalt, and wherein the total cobalt content in the composite particle is less than 20 mole percent.

47. The composite particles of claim 44, wherein the shell layer is selected from the group consisting of Li[Li_{0.2}Mn_{0.54}Ni_{0.13}Co_{0.13}]O₂ and Li[Li_{0.06}Mn_{0.525}Ni_{0.415}]O₂.

48. The composite particles of claim 44, wherein the core comprises Li[Ni_{2/3}Mn_{1/3}]O₂.

49. The composite particles of claim 44, wherein Mn and Ni are present in the shell layer in a first molar ratio of Mn to Ni that is greater than one.

50. The composite particles of claim 44, wherein Mn and Ni are present in the core in a second molar ratio of Mn to Ni, less than or equal to one.

51. A cathode for a lithium-ion battery, the cathode comprising a current collector having a cathode composition disposed thereon, the cathode composition comprising:
composite particles according to claim 1;
at least one conductive diluent; and
a binder.

52. The cathode of claim 51, wherein the cathode has a density of greater than or equal to 2.8 grams per cubic centimeter.

53. A lithium-ion battery comprising an anode, a separator, an electrolyte, and the cathode of claim 51.

54. The lithium-ion battery of claim 53, wherein the lithium-ion battery is capable of being cycled with charging to at least 4.6 V versus Li/Li⁺ with a capacity fade of less than 10 percent after 100 charge-discharge cycles.

55. A method of making composite particles, the method comprising:
forming core precursor particles comprising a first metal salt;
disposing a shell layer comprising a second metal salt on at least some of the core precursor particles to provide composite particle precursor particles, wherein the first and second metal salts are different;
drying the composite particle precursor particles to provide dried composite particle precursor particles;
combining the dried composite particle precursor particles with a lithium source material to provide a powder mixture; and
firing the powder mixture in air or oxygen to provide composite particles, wherein the composite particles each comprise:
a core comprising a layered lithium metal oxide having an O3 crystal structure, wherein if the layered lithium metal oxide is incorporated into a cathode of a lithium-ion cell, and the lithium-ion cell is charged to at least 4.6 volts versus Li/Li⁺ and then discharged, then the layered lithium metal oxide exhibits no dQ/dV peaks below 3.5 volts, and wherein the core comprises from 30 to 85 mole percent of the composite particle, based on the total moles of atoms of the composite particle; and
a shell layer enclosing the core, wherein the shell layer comprises an oxygen-loss, layered lithium metal oxide having an O3 crystal structure.

56. The method of claim 55, wherein the capacity of the composite particle is greater than the capacity of the core.

57. The method of claim 55, wherein the layered lithium metal oxide comprises nickel, manganese, and cobalt, and wherein the total cobalt content in the composite particle is less than 20 mole percent.

58. The method of claim 55, wherein the shell layer is selected from the group consisting of Li[Li_{0.2}Mn_{0.54}Ni_{0.13}Co_{0.13}]O₂ and Li[Li_{0.06}Mn_{0.525}Ni_{0.415}]O₂.

59. The method of claim 55, wherein the core comprises Li[Ni_{2/3}Mn_{1/3}]O₂.

60. A method of making composite particles, the method comprising:
forming core particles comprising a layered lithium metal oxide;
disposing a shell layer comprising a metal salt on at least some of the core particles to provide composite particle precursor particles;
drying the composite particle precursor particles to provide dried composite particle precursor particles;
combining the dried composite particle precursor particles with a lithium-ion source material to provide a powder mixture; and
firing the powder mixture in air or oxygen to provide composite particles, wherein the composite particles each comprise:
a core comprising a layered lithium metal oxide having an O3 crystal structure, wherein if the layered lithium metal oxide is incorporated into a cathode of a lithium-ion cell, and the lithium-ion cell is charged to at least 4.6 volts versus Li/Li⁺ and then discharged, then the layered lithium metal oxide exhibits no dQ/dV peaks below 3.5 volts, and wherein the core comprises from 30 to 85 mole percent of the composite particle, based on the total moles of atoms of the composite particle; and
a shell layer enclosing the core, wherein the shell layer comprises an oxygen-loss, layered lithium metal oxide having an O3 crystal structure.

61. The method of claim 60, wherein the capacity of the composite particle is greater than the capacity of the core.

62. The method of claim 60, wherein the layered lithium metal oxide comprises nickel, manganese, and cobalt, and wherein the total cobalt content in the composite particle is less than 20 mole percent.

63. The method of claim 60, wherein the shell layer is selected from the group consisting of Li[Li_{0.2}Mn_{0.54}Ni_{0.13}Co_{0.13}]O₂ and Li[Li_{0.06}Mn_{0.525}Ni_{0.415}]O₂.

64. The method of claim 60, wherein the core comprises Li[Ni_{2/3}Mn_{1/3}]O₂.

65. Composite particles, wherein each of the composite particles comprises:
a core comprising a layered lithium metal oxide having an O3 crystal structure, wherein if both Mn and Ni are present in the core, then a molar ratio of Mn to Ni is less than or equal to one; and
a shell layer disposed on the core, wherein the shell layer comprises a oxygen-loss layered lithium metal oxide having an O3 crystal structure, wherein if both Mn and Ni are present in the shell layer, then a molar ratio of Mn to Ni is greater than one.

66. The composite particles of claim 65, wherein the capacity of the composite particle is greater than the capacity of the core.

67. The composite particles of claim 65, wherein the layered lithium metal oxide comprises nickel, manganese, and cobalt, and wherein the total cobalt content in the composite particle is less than 20 mole percent.

68. The composite particles of claim 65, wherein the shell layer is selected from the group consisting of Li[Li_{0.2}Mn_{0.54}Ni_{0.13}Co_{0.13}]O₂ and Li[Li_{0.06}Mn_{0.525}Ni_{0.415}]O₂.

69. The composite particles of claim 65, wherein the core comprises Li[Ni_{2/3}Mn_{1/3}]O₂.

70. The composite particles of claim 65, wherein Mn and Ni are present in the shell layer in a first molar ratio of Mn to Ni that is greater than one.

71. The composite particles of claim 65, wherein Mn and Ni are present in the core in a second molar ratio of Mn to Ni, less than or equal to one.

72. A cathode for a lithium-ion battery, the cathode comprising a current collector having a cathode composition disposed thereon, the cathode composition comprising:
composite particles according to claim 65;
at least one conductive diluent; and
a binder.

73. The cathode of claim 72, wherein the cathode has a density of greater than or equal to 2.8 grams per cubic centimeter.

74. A lithium-ion battery comprising an anode, a separator, an electrolyte, and the cathode of claim 72.

75. The lithium-ion battery of claim 74, wherein the lithium-ion battery is capable of being cycled with charging to at least 4.6 V versus Li⁺/Li electrode with a capacity fade of less than 10 percent after 100 charge-discharge cycles.

76. A method of making composite particles, the method comprising:
forming core precursor particles comprising a first metal salt;
disposing a shell layer comprising a second metal salt on at least some of the core precursor particles to provide composite particle precursor particles, wherein the first and second metal salts are different;
drying the composite particle precursor particles to provide dried composite particle precursor particles;
combining the dried composite particle precursor particles with a lithium source material to provide a powder mixture; and
firing the powder mixture in air or oxygen to provide composite particles, wherein the composite particles each comprise:
a core comprising a layered lithium metal oxide having an O3 crystal structure, wherein if both Mn and Ni are present in the core, then a molar ratio of Mn to Ni is less than or equal to one; and
a shell layer disposed on the core, wherein the shell layer comprises a oxygen-loss layered lithium metal oxide having an O3 crystal structure, wherein if both Mn and Ni are present in the shell layer, then a molar ratio of Mn to Ni is greater than one.

77. The method of claim 76, wherein the capacity of the composite particle is greater than the capacity of the core.

78. The method of claim 76, wherein the layered lithium metal oxide comprises nickel, manganese, and cobalt, and wherein the total cobalt content in the composite particle is less than 20 mole percent.

79. The method of claim 76, wherein the shell layer is selected from the group consisting of Li[Li_{0.2}Mn_{0.54}Ni_{0.13}Co_{0.13}]O₂ and Li[Li_{0.06}Mn_{0.525}Ni_{0.415}]O₂.

80. The method of claim 76, wherein the core comprises Li[Ni_{2/3}Mn_{1/3}]O₂.

81. A method of making composite particles, the method comprising:
forming core particles comprising a layered lithium metal oxide;
disposing a shell layer comprising a metal salt on at least some of the core particles to provide composite particle precursor particles;
drying the composite particle precursor particles to provide dried composite particle precursor particles;
combining the dried composite particle precursor particles with a lithium-ion source material to provide a powder mixture; and
firing the powder mixture in air or oxygen to provide composite particles, wherein the composite particles each comprise:
a core comprising a layered lithium metal oxide having an O3 crystal structure, wherein if the layered lithium metal oxide is incorporated into a cathode of a lithium-ion cell, and the lithium-ion cell is charged to at least 4.6 volts versus Li/Li⁺ and then discharged, then the layered lithium metal oxide exhibits no dQ/dV peaks below 3.5 volts, and wherein the core comprises from 30 to 85 mole percent of the composite particle, based on the total moles of atoms of the composite particle; and
a shell layer enclosing the core, wherein the shell layer comprises an oxygen-loss, layered lithium metal oxide having an O3 crystal structure.

82. The method of claim 81, wherein the capacity of the composite particle is greater than the capacity of the core.

83. The method of claim 81, wherein the layered lithium metal oxide comprises nickel, manganese, and cobalt, and wherein the total cobalt content in the composite particle is less than 20 mole percent.

84. The method of claim 81, wherein the shell layer is selected from the group consisting of Li[Li_{0.2}Mn_{0.54}Ni_{0.13}Co_{0.13}]O₂ and Li[Li_{0.06}Mn_{0.525}Ni_{0.415}]O₂.

85. The method of claim 81, wherein the core comprises Li[Ni_{2/3}Mn_{1/3}]O₂.

86. Composite particles, wherein each of the composite particles comprises:
a core comprising Li[Ni_{2/3}Mn_{1/3}]O₂; and
a shell layer disposed on the core, wherein the shell layer comprises material selected from the group consisting of Li[Li_{0.2}Mn_{0.54}Ni_{0.13}Co_{0.13}]O₂ and Li[Li_{0.06}Mn_{0.525}Ni_{0.415}]O₂.
